(19) United States
(12) Patent Application Publication
(10) Pub. No.: US 2014/0090572 A1
(43) Pub. Date: Apr. 3, 2014

(54) INFLATOR

(71) Applicant: Toyoda Gosei Co., Ltd., Kiyosu-shi (JP)

(72) Inventors: Kengo NAKASHIMA, Aichi (JP); Keisuke MORI, Aichi (JP)

(73) Assignee: Toyoda Gosei Co., Ltd., Kiyosu-shi (JP)

(21) Appl. No.: 14/010,722

(22) Filed: Aug. 27, 2013

(30) Foreign Application Priority Data
Sep. 28, 2012 (JP) 2012-215577

(51) Int. Cl. B60R 21/264; B60R 21/272

(52) U.S. Cl. CPC B60R 21/264; B60R 21/272
USPC 102/363

(57) ABSTRACT

An inflator of the present invention is a hybrid type inflator in which an inside of a housing is charged with a pressurized gas and a gas generating agent capable of generating a gas at time of combustion. In the inflator of the present invention, a quantity of heat generated by the gas generating agent at the time of the combustion is set within a range of 6,000 to 10,000 J/g, and a molar ratio of the pressurized gas and the combustion gas generated by the combustion of the gas generating agent is set within a range of 80 to 130.

### BACKGROUND OF THE PRESENT INVENTION

1. Field of the Present Invention

The present invention relates to a hybrid type inflator having a structure that an inside of a housing is charged with a pressurized gas and a gas generating agent capable of generating a gas at the time of combustion.

2. Description of the Related Art

The hybrid type inflator of this kind is used for expanding an air bag in an air bag device, and the air bag has been expanded by allowing a combustion gas generated by combustion of a gas generating agent and a pressurized gas to flow out of a gas ejection opening part disposed on one end side of a housing and to flow into the air bag at the time of actuation. As the inflator, there has hitherto been proposed an inflator using a gas generating agent which generates a quantity of heat within a range of 6,000 to 10,000 J/g at the time of combustion and charged with this gas generating agent and a pressurized gas composed of only an inert gas, at a charge ratio so as to give a molar ratio of the pressurized gas and a combustion gas generated by the combustion of the gas generating agent within a range of 20 to 40 (for example, see JP-A-2010-36814). In this inflator, the amount of the gas generating agent used is more decreased than ever before by using the gas generating agent having a high calorific value at the time of the combustion, thereby realizing downsizing and suppressing mist generation.

This conventional inflator is charged with about 0.9 to 1.7 mol of the pressurized gas, and has been suitably used at the time of expanding an air bag set to about 20 to 30 litters in volume at the completion of the expansion.

However, in the case used for an air bag (for example, an air bag for head protection) which is large in volume at the completion of the expansion and in which the internal pressure is required to be maintained after the completion of the expansion for a long period of time, when this conventional inflator is diverted, simply increasing the charged amounts of the pressurized gas and the gas generating agent at a constant charge ratio thereof in order to increase the generated amount of an expansion gas, the necessary amount of the expansion gas can be secured, and further, the air bag can be rapidly expanded. However, because of a large charged amount of the gas generating agent, the pressurized gas is increased in temperature higher than necessary, resulting in an excessively high internal pressure in an early stage of the expansion. It is therefore difficult to maintain the internal pressure after the completion of the expansion for a long period of time.

### SUMMARY OF THE PRESENT INVENTION

The present invention solves the above-mentioned problems, and an object thereof is to provide an inflator which can rapidly expand a large volume air bag and is capable of maintain the internal pressure after the completion of the expansion for a long period of time.

An inflator according to the present invention is a hybrid type inflator having a structure that an inside of a housing is charged with a pressurized gas and a gas generating agent capable of generating a gas at the time of combustion, wherein

the quantity of heat generated by the gas generating agent at the time of the combustion is set within a range of 6,000 to 10,000 J/g, and

the molar ratio of the pressurized gas and the combustion gas generated by the combustion of the gas generating agent is set within a range of 80 to 130.

In the inflator of the present invention, since the charge ratio of the gas generating agent to the pressurized gas is set low, it can be suppressed that the pressurized gas is increased in temperature higher than necessary at the time of actuation. For this reason, when the air bag is expanded, the internal pressure can be suppressed from increasing higher than necessary in the early stage of the expansion of the air bag. Accordingly, the expansion gas can be suppressed from leaking from the air bag after the completion of the expansion, and it becomes possible to maintain the internal pressure after the completion of the expansion for a long period of time. Of course, also in the inflator of the present invention, there is used the gas generating agent which generates a high quantity of heat at the time of the combustion. It is therefore possible to thermally expand the pressurized gas instantaneously at the time of the combustion, and it is also possible to rapidly expand the air bag in an early stage of the actuation. For this reason, when the inflator of the present invention is applied to the large volume air bag, the air bag can be rapidly expanded, and it also becomes possible to maintain the internal pressure after the completion of the expansion for a long period of time.

Accordingly, in the inflator of the present invention, the large volume inflator can be rapidly expanded, and the internal pressure after the completion of the expansion can be maintained for a long period of time.

### BRIEF DESCRIPTION OF THE DRAWINGS

FIG. 1 is a schematic vertical sectional view showing an inflator which is one embodiment of the present invention.

FIG. 2 is a graph showing the relationship between the internal pressure and the internal temperature measured of an air bag expanded using an inflator of one embodiment of the present invention.

### DESCRIPTION OF THE EMBODIMENTS

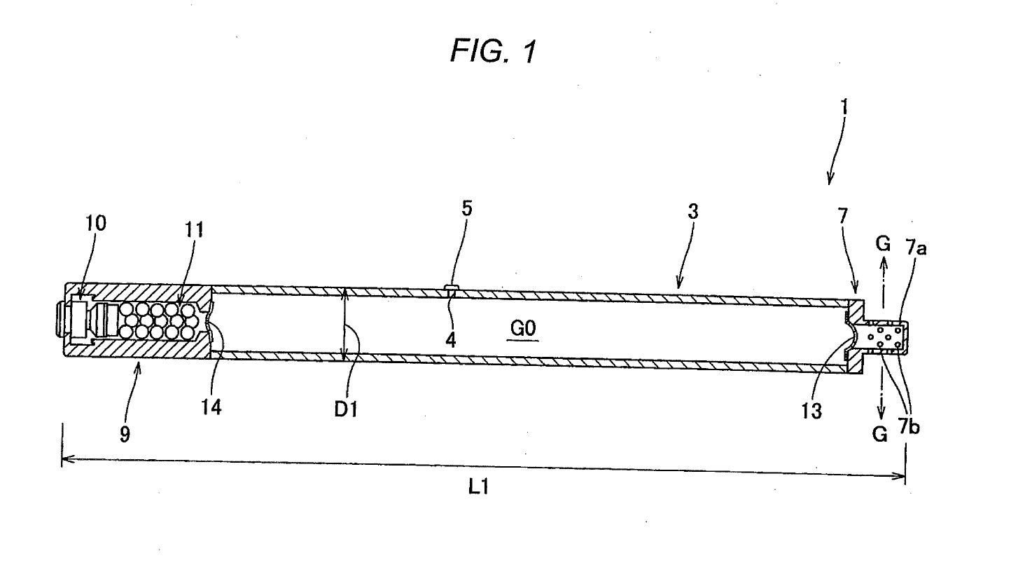

One embodiment of the present invention will be described below based on the drawings. An inflator 1 of this embodiment is of a hybrid type having a structure that an inside thereof is charged with a pressurized gas G0 and a gas generating agent 11 capable of generating a gas at the time of combustion, and in the case of this embodiment, it is of a cylinder type having a substantially cylindrical outer shape, as shown in FIG. 1. The inflator 1 has a structure that an ejection-side cap part 7 is fixed by welding or the like to one end side of a housing 3 formed of a substantially cylindrical steel metal pipe and that a squib-side cap part 9 is fixed by welding or the like to the other end side of the housing 3. The inside of the housing is charged with the pressurized gas G0, and the squib-side cap part 9 is allowed to retain the gas generating agent 11 and a squib 10 for igniting the gas generating agent 11. The ejection-side cap part 7 is provided with a projected head part 7a having a plurality of gas ejection openings 7b. Incidentally, the inflator 1 of this embodiment is of an elongated form in which the length dimension is set to about 11 times the outside diameter dimension. In the inflator 1 of this embodiment, the housing 3 is set within a range of 100 to 220 ml (desirably 110 to 150 ml) in volume.

In the housing 3, bursting plates 13 and 14 which are capable of bursting by an increase in internal pressure or the generation of impact waves involved in ignition of the gas generating agent 11 are each arranged at a boundary site between the housing and the ejection-side cap part 7 and a boundary site between the housing and the squib-side cap part 9, respectively. These bursting plates 13 and 14 are disposed so as to block from the side of the housing 3. Further, a charging opening 4 for charging the pressurized gas G0 is formed at a predetermined position (in this embodiment, at approximately the center in an axial direction) of the housing 3. The charging opening 4 is closed by a closing pin 5. The inside of the housing 3 is charged with the pressurized gas G0. In this embodiment, a mixed gas of argon gas and helium gas is used as the pressurized gas G0. For the mixing ratio of argon gas and helium gas, the argon gas is desirably allowed to be contained in an amount of 90% or more by molar ratio. The reason for this is that when the content of the helium gas is increased because the argon gas is light and easily outgases through a foundation cloth constituting the air bag, it is difficult to maintain the internal pressure for a long period of time after the completion of the expansion of the air bag. In this embodiment, the pressurized gas G0 is charged in the housing at a charge pressure within a range of 55 to 65 MPa.

The squib 10 is provided in a position opposed to the bursting plate 14 provided in the housing 3, in the squib-side cap part 9. The squib 10 is housed in the squib-side cap part 9, specifically in such a manner that a leading end side thereof is inserted into the squib-side cap part 9, and that a base side thereof is exposed to the outside of the squib-side cap part 9. When the inflator 1 is mounted on a vehicle as an air bag device, a connector to which a lead wire (not shown) for actuation signal input is connected is connected to the base side. In this embodiment, the squib 10 has a structure of housing an agent capable of generating a small amount of combustion gas in the inside thereof. When the inflator 1 is mounted on the vehicle as the air bag device, the squib 10 is electrically connected to a control device of the vehicle through this lead wire and operates so as to combust the agent in the inside thereof upon reception of an actuation signal from the control device, thereby combusting the gas generating agent 11.

The gas generating agent 11 is charged in a region between the squib 10 and the bursting plate 14, in the squib-side cap part 9. The gas generating agent 11 makes it possible to use the combustion gas generated at the time of the combustion, together with the pressurized gas G0 for the expansion of the air bag, and specifically, there is used the gas generating agent in which the calorific value at the time of the combustion is set within a range of 6,000 to 10,000 J/g. When the calorific value is less than 6,000 J/g, it is impossible to sufficiently thermally expand the pressurized gas G0, because the quantity of heat generated at the time of the combustion is too low, resulting in a failure to obtain a desired output. On the other hand, it is difficult to obtain the gas generating agent having a calorific value exceeding 10,000 J/g.

In the case of this embodiment, specifically, a fuel, an oxidizing agent and a metal powder are appropriately mixed together with a binding agent, and molded into a predetermined form (in the case of this embodiment, a spherical form). The resulting molded product is used as the gas generating agent 11. Examples of the fuels include triadine derivatives, tetrazole derivatives, triazole derivatives, guanidine derivatives, azodicarbonamide derivatives, hydrazine derivatives and the like, and these fuels may be used either alone or as a mixture of two or more thereof. Examples of the oxidizing agents include strontium nitrate, potassium nitrate, ammonium nitrate, potassium perchlorate, copper oxide, iron oxide, basic copper nitrate and the like, and these oxidizing agents may be used either alone or as a mixture of two or more thereof. Examples of the metal powders include boron powder, magnalium powder and the like. The metal powder is added for the purpose of increasing the calorific value at the time of the combustion, and in the case of this embodiment, boron is preferably used, because boron has a high combustion heat and a large calorific value is obtained by use thereof in small amounts. Examples of the binding agents include a sodium salt of carboxymethyl cellulose, hydroxyethyl cellulose, hydroxypropyl cellulose, hydroxypropylmethyl cellulose, starch, polyvinyl alcohol, guar gum, microcrystalline cellulose, polyacrylamide, calcium stearate and the like, and these binding agents may be used either alone or as a mixture of two or more thereof. Incidentally, the binding agent used is preferably water-soluble, from the viewpoint of handling properties.

Then, in the inflator 1 of this embodiment, the inside thereof is charged with the pressurized gas G0 and the gas generating agent 11 in such a manner that the molar ratio (pressurized gas/combustion gas) of the pressurized gas to the combustion gas generated by the combustion of the gas generating agent 11 is within a range of 80 to 130. When the pressurized gas/combustion gas molar ratio is less than 80, the charged amount of the gas generating agent 11 is too large, which causes the pressurized gas to be increased in temperature higher than necessary. Although the internal pressure in the early stage of the expansion of the air bag at the time of use can be rapidly increased, it is difficult to maintain the internal pressure of the air bag after the completion of the expansion for a long period of time. Conversely, when the pressurized gas/combustion gas molar ratio exceeds 130, the charged amount of the gas generating agent 11 is too small to obtain a necessary quantity of heat. Accordingly, the pressurized gas cannot be sufficiently increased in temperature, and it is difficult to secure the predetermined internal pressure in the early stage of the expansion of the air bag at the time of use.

In the inflator 1 of this embodiment, when the actuation signal from the control device is inputted through the lead wire (not shown) in a state where mounted on the vehicle together with the air bag device, the squib 10 is actuated to combust the gas generating agent 11, thereby generating the combustion gas. When the internal pressure of the squib-side cap part 9 is increased by the combustion gas generated, the bursting plate 14 bursts to allow the combustion gas to enter the housing 3. Then, when the pressurized gas G0 in the housing 3 is heated by this combustion gas to increase the internal pressure of the housing 3, the bursting plate 13 bursts to allow the pressurized gas G0 and the combustion gas to flow out as an expansion gas G from the gas ejection openings 7b provided in the ejection-side cap part 7 to the outside of the inflator 1, thereby expanding the air bag of the air bag device.

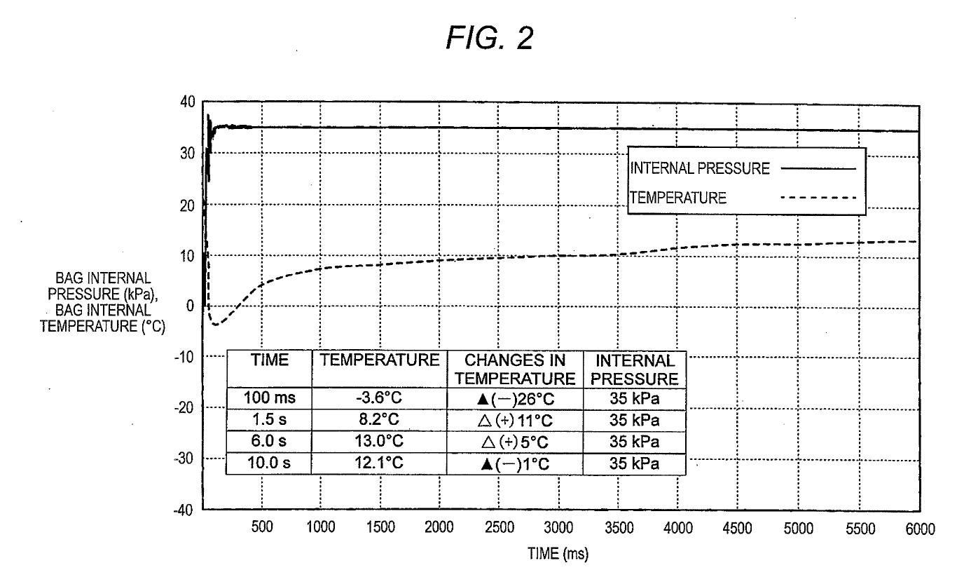

Using the inflator satisfying the requirements of the present invention, the internal pressure of the air bag and the temperature in the air bag at the time when the air bag was expanded were measured. A graph showing the relationship therebetween is shown in FIG. 2. In the inflator used in this measurement, the housing volume was set to 114 ml, the length dimension L1 was set to 355 mm, and the outside diameter dimension D1 was set to 26.2 mm (see FIG. 1). The inside of the housing was charged at a charge pressure of 60 MPa with 3.0 mol of a mixed gas obtained by mixing argon gas and helium gas at a molar ratio of Ar/He=0.96/0.04, and charged with 2.4 g of a gas generating agent (calorific value: 6,600 J/g, amount of combustion gas generated: 0.03 mol/g) having the composition shown in Table 1. That is to say, in this inflator, the molar ratio (pressurized gas/combustion gas) of the pressurized gas and the combustion gas generated by the combustion of the gas generating agent is 100. Then, this inflator was actuated under ordinary temperature and pressure to expand an air bag having a volume of 60 litters, and the internal pressure and the internal temperature were measured. Particularly, the inflator was connected to a rear end part of the approximately rectangular air bag formed of non-coat fabric in which the air permeability was set to 0.6 litter/cm²·min under 19.6 kPa (a high pressure process) and enlarged in width dimension on the longitudinal direction side, and the internal pressure and the internal temperature were measured at approximately the center in the longitudinal direction.

TABLE 1

| | Content (wt %) |
|---|---|
| 5-Aminotetrazole (Fuel) | 4.0 |
| Boron (Metal Powder) | 15.0 |
| Hydroxypropylmethyl Cellulose (binding agent) | 6.0 |
| Potassium Nitrate (Oxidizing Agent) | 75.0 |

According to the results of this measurement test, the internal pressure of the air bag rapidly increases immediately after the start of the actuation of the inflator, and reaches about 38 kPa, a maximum, after 50 ms. Thereafter, the internal pressure of the air bag comes to 35 kPa after 100 ms, and continues to be approximately constant. Even after 6,000 ms (6 seconds), a value of 34 kPa is maintained. Further, the internal temperature of the air bag, which is ordinary temperature (23° C.) before the actuation, starts to rapidly decrease from immediately after the start of the actuation of the inflator, and reaches −3.6° C. after 100 ms. Thereafter, the internal temperature slowly increases, and comes to 13.0° C. after 6,000 ms.

From the results of the above-mentioned measurement test, the following can be estimated. The inflator 1 used in the measurement test is of an elongated form in which the length dimension L1 is set to 355 mm, and the outside diameter dimension D1 is set to 26.2 mm. The squib 10 is disposed on one end side of the housing 3 charged with the pressurized gas G0, and the housing is charged with the gas generating agent 11. On the other end side, the gas ejection openings 7b for ejecting the expansion gas G are disposed. In an early stage of the actuation, therefore, the combustion gas generated by the combustion of the gas generating agent 11 flows into the housing 3, resulting in heating the combustion gas G0. The combustion gas increases the temperature of the pressurized gas G0 charged in the housing of the elongated form, in turn from a region on the side of the squib 10. Before the combustion gas increases the temperature of the whole pressurized gas G0 (before heat of the combustion gas propagates to the side of the gas ejection openings 7b), the internal pressure in the housing 3 is increased to cause a burst of the bursting plate 13 dividing the housing 3 and the gas ejection openings 7b. The pressurized gas (cold gas) charged in the region on the side of the gas ejection openings 7b and not increased in temperature first flows into the air bag as the expansion gas. This cold gas is adiabatically expanded in the air bag to conceivably rapidly decrease the temperature in the air bag. Further, at this time, in the inflator 1 used in this measurement test, the gas generating agent 11 is set to 6,600 J/g in the calorific value, so that a high quantity of heat is instantaneously generated at the start of the combustion. The pressurized gas G0 charged on the side of the squib 10 in the housing 3 can be rapidly adiabatically expanded, which causes the pressurized gas (cold gas) not increased in temperature to rapidly flow into the air bag, thereby conceivably rapidly increasing the internal pressure in the early stage of the actuation. Then, the air bag completes the expansion after an elapse of 14 ms from the start of the actuation. Since this air bag is formed of non-coat fabric in which the air permeability is set to 0.6 litter/cm²·min under 19.6 kPa (a high pressure process) as described above, the combustion gas which flows into the inside thereof leaks from between yarns constituting a foundation cloth, after the completion of the expansion. According to the inflator 1 of this embodiment, the pressurized gas increased in temperature by the combustion gas flows into the air bag, and thermally expands the expansion gas which has flowed into the air bag, thereby conceivably not only compensating for the leakage of the expansion gas and gradually increasing the temperature in the air bag, but also maintaining the internal pressure. Incidentally, although described in the graph in FIG. 2, the internal pressure of the air bag after an elapse of 10,000 ms (10 seconds) from the start of the actuation is maintained at 33 kPa, and the internal temperature is 12.1° C.

That is to say, in the inflator 1 of this embodiment, since the charge ratio of the gas generating agent 11 to the pressurized gas G0 is set low, it can be suppressed that the pressurized gas G0 is increased in temperature higher than necessary at the time of the actuation. For this reason, when the air bag is expanded, the internal pressure can be suppressed from increasing higher than necessary in the early stage of the expansion of the air bag. Accordingly, the expansion gas can be suppressed from leaking from the air bag after the completion of the expansion, and it becomes possible to maintain the internal pressure after the completion of the expansion for a long period of time. Of course, also in the inflator 1 of this embodiment, there is used the gas generating agent 11 which generates a high quantity of heat at the time of the combustion. It is therefore possible to thermally expand the pressurized gas instantaneously at the time of the combustion, and it is also possible to rapidly expand the air bag in the early stage of the actuation.

Accordingly, the inflator 1 of this embodiment can rapidly expand the air bag in which the volume is set as large as 50 to 100 litters, and can allow the internal pressure after the completion of the expansion to be maintained for a long period of time.

In particular, in the inflator 1 of this embodiment, the internal pressure can be maintained approximately constant for a long period of time until after 5 seconds from the start of the actuation, and can be rapidly increased immediately after the start of the actuation. This inflator is therefore suitable for a head protection air bag device having a structure that the air bag folded and housed on the upper edge portion side of a window is spread out and expanded so as to cover the window. When such an inflator is used, the head of an occupant can be protected by the air bag rapidly expanded at the time of a side crash of a vehicle. Even when the vehicle is thereafter rolled over, the head of the occupant can be adequately protected by the air bag expanded with good cushioning properties while maintaining the internal pressure.

What is claimed is:

1. An inflator that is a hybrid type inflator in which an inside of a housing is charged with a pressurized gas and a gas generating agent capable of generating a gas at time of combustion, wherein:
a quantity of heat generated by the gas generating agent at the time of the combustion is set within a range of 6,000 to 10,000 J/g; and
a molar ratio of the pressurized gas and the combustion gas generated by the combustion of the gas generating agent is set within a range of 80 to 130.
